(19) United States
(12) Patent Application Publication
(10) Pub. No.: US 2017/0282800 A1
(43) Pub. Date: Oct. 5, 2017

(54) Vehicle Backing Assistance System

(71) Applicant: BAKSAFE! L.L.C., Kaukauna, WI (US)

(72) Inventors: Luke Haen, Kaukauna, WI (US); Gerald Haen, Kaukauna, WI (US); Yvonne Haen, Kaukauna, WI (US)

(21) Appl. No.: 15/472,901

(22) Filed: Mar. 29, 2017

Related U.S. Application Data
(60) Provisional application No. 62/314,457, filed on Mar. 29, 2016.

(51) Int. Cl. B60R 1/00

(52) U.S. Cl. CPC B60R 1/00; B60R 2300/80

(57) ABSTRACT

A vehicle backing assistance system is described. The vehicle backing assistance system includes a first device and a second device. The first device includes a camera, a microphone, a light, an ultrasonic proximity sensor, a significantly waterproof body, and a battery. The first device can then be releasably connected to a rear end of a vehicle. Images, video, audio, and depth sensing are collected by the first device, which are then transmitted to the second device at a remote location. As a result, a user can monitor the images, video, audio, and depth sensing using software on the second device that are collected by the first device while located away from the second device. For instance, the user could monitor that rear end of a vehicle while being located at a front cab of the vehicle. This can be useful when the user is backing the vehicle.

### CROSS-REFERENCE(S) TO RELATED APPLICATION(S)

This application claims the benefit of priority on U.S. Provisional Patent Application Ser. No. 62/314,457, filed on Mar. 29, 2016 and entitled Vehicle Backing Assistance Device, the entirety of which is hereby incorporated by reference.

### BACKGROUND OF THE INVENTION

### 1. Field of the Invention

The present invention relates in general to the field of operation of large motor vehicles, and especially heavy commercial vehicles, that are difficult to drive in reverse. More particularly, the present invention relates to a portable device that allows a user to see behind the vehicle while the vehicle is being backed.

### 2. Discussion of the Related Art

As is known to those skilled in the art, it can be difficult to back up large vehicles, especially those with trailers attached to the vehicle including semitrucks, commercial motor vehicles, personal campers, boat trailers, all-terrain vehicle trailers, trailers with large construction equipment, military vehicles, and the like. Oftentimes, this is due to the pivot point located where the trailer is attached to the towing vehicle. These difficulties are exacerbated by the long distance between the front cab and the rear end of the vehicle and trailer, and the fact that there are no mirrors that show what might be located directly behind the trailer.

Because of these issues, it is common for trailers to be damaged during routine operation, which results in significant repair expenses, and can cause the trailer to be inoperable until repairs are completed. As a result, a trailer owner will not only have to pay money to fix the trailer, but he or she will additionally be losing the money that would be generated had the trailer remained in working condition. Another concern when the driver cannot see the rear of the trailer is the safety of individuals moving around the rear of the trailer. Significant cost savings would incur in the event that accidents and injuries associated with backing a vehicle could be reduced.

Several products have been introduced to address these concerns. For instance, many personal vehicles can be equipped with cameras located in the rear of the vehicle, which can then be displayed on a dash while the vehicle is in reverse. Unfortunately, this solution is only acceptable for single vehicles and would not be operable when a trailer is then attached to the rear of the vehicle.

Another previously identified solution was to provide a wireless camera that is equipped to wirelessly transmit video through a built-in Wi-Fi hotspot network to a user's cell phone. Traditionally, these wireless cameras and a corresponding Wi-Fi hotspot are installed to a specific vehicle or trailer and cannot be moved in the event that the user switches trailers or the towing vehicle. Similarly, a wireless camera can be used in connection with a monitor through a radio frequency.

Alternatively, a magnetic smartphone case can be used to secure a smartphone to the rear of a vehicle. These types of cases traditionally include somewhat weak magnets. As a result, there is risk that the case would not remain attached to the rear of the vehicle, which would likely result in damage to the phone.

What is needed therefore is a vehicle backing assistance system that allows the user to safely and efficiently back the vehicle. What is farther needed is a vehicle backing assistance system that includes additional features that improve operability.

### SUMMARY AND OBJECTS OF THE INVENTION

By way of summary, the present invention is directed to a vehicle backing assistance system. A primary object of the invention is to provide an apparatus that allows a user to monitor a rear end of a vehicle while sitting in a front cab of the vehicle. This is achieved using a first device that is configured to releasably connect to the rear end of the vehicle and a second device capable of displaying images, playing audio, and displaying other information transmitted from the first device. The second device has installed software that interacts with the features and functions of the first device. As a result, the second device can receive and display images taken by the first device, for instance, using a camera contained within a body of the first device. As a result, a user can view the images, hear the audio, and view other information from the rear of the vehicle collected by the first device at the front cab of the vehicle using the second device. The first device could be releasably connected to the rear end of the vehicle using an attachment mechanism, for instance at least one magnet such that the first device could be secured to a metallic surface of the vehicle. Alternatively, the attachment mechanism could be a mounting bracket, a clamp, a screw, a bolt, a strap, or a fastener. The second device could be a number of different devices capable of displaying images from the first device, including for instance a smartphone, a tablet, or a computer.

In accordance with another aspect of the invention, the vehicle backing assistance system could be used with a commercial motor vehicle, a military defense vehicle, an emergency vehicle, a personal camper, a boat trailer, an all terrain vehicle trader, a heavy equipment trailer, a bus, and a construction crane.

In accordance with another aspect of the invention, the first device may contain additional features. For instance, the first device could have a light source configured to illuminate the rear end of the vehicle. The first device could also have an ultrasonic proximity sensor. Also, the first device may have a microphone that collects audible information from the rear of the vehicle. Furthermore, these functions can be controlled through software on the second device.

In accordance with another aspect of the invention, the vehicle backing assistance first device and/or second device could be powered by a battery or by solar panels mounted to the vehicle.

In accordance with another aspect of the invention, the first device could be used with a boat trailer when the first device is waterproof and the first device is made of a buoyant material capable of floating.

Another object of the invention is a method of using a vehicle backing assistance system. Initially, a first device with a camera is releasably mounted to a rear end of a vehicle. Next, the first device is wirelessly connected to the second device. Once connected, the first device would capture real-time video or images and then transmit the real-time video or images to the second device. A user could then monitor the real-time video or images on the second device as the vehicle is moved. Similarly, the first device could also capture a real-time audio through a microphone contained within the first device. The real-time audio can then be transmitted from the first device to the second device. This allows a user to monitor the real-time audio on the second device as the vehicle is moved. Further still, the first device may have a proximity sensor, which collects information related to a plurality of physical items located about the rear end of the vehicle. This information is then transmitted to the second device such that a user can monitor this information while the vehicle is moved. Upon completion of moving the vehicle, the first device could be dismounted from the rear end of the vehicle. After removal, the first device could then be mounted to the rear end of a different vehicle.

Another object of the invention is a method of using a vehicle backing assistance system and software associated therewith to control functions of the first device. For instance, a user could control the brightness level of a light, viewing angle of a camera, magnification level of a camera, contrast level of a camera, volume level of a microphone, and sensitivity of a proximity sensor.

In another object of the invention, a method of using software associated with a vehicle backing assistance system to influence a user's experience with the second device is provided. For instance, the software could overlay projected travel lines over the video image displayed on the second device to assist in backing. Additionally, the software could adjust the second device's display brightness based on ambient light conditions. Further still, the software could adjust the second device's audio volume. Similarly, the software could play an audible alarm or display a visual alarm through the second device based on hazardous conditions detected by the first device.

Another object of the invention is a method of using a vehicle backing assistance system. The software could provide relevant data from a database of locations. This database could include dock locations, entrance, and exit routes. A user could record the location of an event and attach important notes or images to be tied to a specific location for later reference. This reference data could be made private or could be stored in a database that all users of this system could have access to.

These, and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views, and in which:

FIG. 1 illustrates a front elevation view of a first device associated with a vehicle backing assistance system;

FIG. 2 illustrates a rear elevation view of the first device associated with the vehicle backing assistance system of FIG. 1;

FIG. 3 illustrates a bottom side perspective view of the first device associated with the vehicle backing assistance system of FIGS. 1 and 2;

FIG. 4 illustrates a top side perspective view of the first device associated, with the vehicle backing assistance system of FIGS. 1-3;

FIG. 5 illustrates a back side perspective view of the first device associated with the vehicle backing assistance system of FIGS. 1-4;

FIG. 6 illustrates the first device associated with the vehicle backing assistance system of FIGS. 1-5 being installed onto a rear end of a vehicle; and

FIG. 7 illustrates a second device associated with the vehicle backing assistance system.

In describing the preferred embodiment of the invention which is illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose. For example, the words connected, attached, or terms similar thereto are often used. They are not limited to direct connection but include connection through other elements where such connection is recognized as being equivalent by those skilled in the art.

### DESCRIPTION OF PREFERRED EMBODIMENTS

The present invention and the various features and advantageous details thereof are explained more fully with reference to the non-limiting embodiments described in detail in the following description.

### 1. System Overview

The invention is a special safety backup device for the heavy commercial vehicle industry. It allows a heavy commercial vehicle operator to view the blind and dead space behind the vehicle during the backing process. Specifically, the invention is a wireless vehicle backing assistance system. It is easily installed and removed with a releasable mount, such as a magnet or a strapping mount. The first device is battery operated and user mounted. Once in place, the first device is powered on and aligned with the vehicle, for instance, a truck. The first device may be integrated with a video camera, microphone, proximity sensor, high intensity light, Wi-Fi hot spot, battery, battery charging circuit, and significantly durable and waterproof enclosure. The first device transmits video signal, audio signal, proximity signal, and battery level indication through Wi-Fi, Bluetooth, and the like to the second device. The second device could be a smartphone, tablet, or computer equipped with software that allows the second device to play real-time audio, display real-time video, and monitor real-time proximity to near objects. The software installed on the second device can include control features through Wi-Fi communication on the first device, including for instance controlling, a light intensity level, a microphone recording level, a viewing angle of a camera, a magnification level of a camera, a contrast level of a camera, and a sensitivity of a proximity sensor.

The driver installs the first device when opening the trailer doors before backing up. As a result, installation of the first device does not require any trips to the rear end of the vehicle, which could reduce efficiency. By installing the first device when opening the trailer doors, wear on the first device can be minimized and the lens is kept clean. There are a number of different possible attachment mechanisms. For instance, a magnet is typically used with steel trailers. However, a clamp, a strap system, or other attachment mechanisms can also be used depending on where the first device is mounted and the user's preference. Thus, the invention can be used with a wide range of vehicles or trailers, including buses, custom trailers, box trucks, etc.

The first device can be easily installed and removed, so that it stays with the driver, not the trailer. This is helpful where a single driver handles multiple trailers a day. In the event that the driver does not own the trailer, this allows the driver to enjoy the benefits of this system without investing in a backing assistance system that is permanently fixed to a single trailer.

Once the system is installed, the driver can more easily monitor changes to the environment between the time of initial arrival and the moment he or she begins to back up the vehicle. Additionally, the driver can see guiding paint lines much easier, as well as any obstructions that might come into the path of the vehicle. Furthermore, the driver will more easily be able to see, hear, or detect any vehicles, pedestrians, or dock equipment that could sneak by once backing has been initiated. Risk of hitting any objects can be mitigated by using this system.

Additional models of the present invention could include a system for use with military vehicles, a system for use with boat trailers, a system for use by outdoor enthusiasts, and any other systems that would allow a user to monitor live footage at a remote location.

### 2. Detailed Description of Preferred Embodiments

Referring now to all of the figures, a vehicle backing assistance system 40 is illustrated. The vehicle hacking assistance system 40 may include several components, including a first device 50 that can be attached to a vehicle 42 and a second device 52. The first device 50 can be releasably attached to a vehicle 42, and more preferably, a rear end 44 of the vehicle 42 to allow a user 41 to see objects located behind the rear end 44 of the vehicle 42 while the user 41 sits in the front cab 46 of the vehicle 42. This vehicle backing assistance system 40 is especially helpful when the user 41 is backing a vehicle 42 with a long distance between the front cab 46 and the rear end 44 of the vehicle 42, as significant blind spots may occur. This is especially true for commercial motor vehicles, semi-trailers, military defense vehicles, emergency vehicles, personal campers, boat trailers, all-terrain vehicle trailers, heavy equipment trailers, buses, construction cranes, and the like. Once the vehicle has been backed, the first device 50 can easily be removed from the rear end 44 of the vehicle 42. This allows the vehicle backing assistance system 40 to be temporarily used with a vehicle 42. The second device 52 can be any devices that include a monitor capable of displaying images, video, or other information taken from the first device 50.

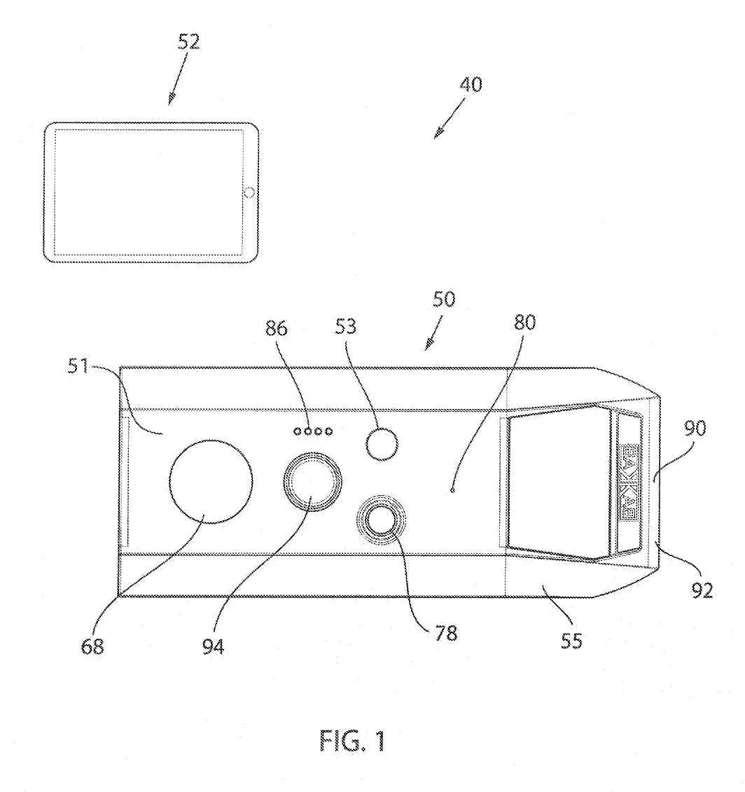

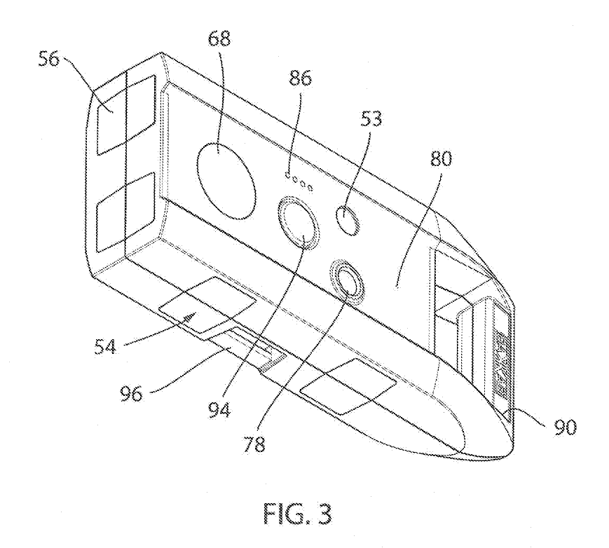

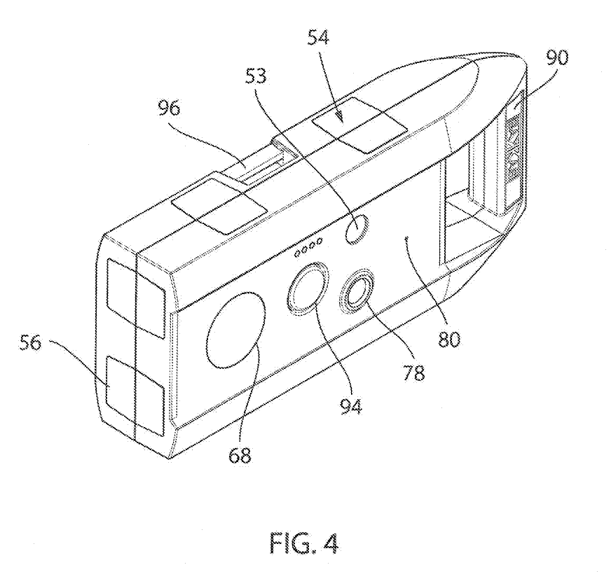

Turning to FIGS. 1-5, the first device 50 is shown with greater detail. The first device 50 has a body 51 that is made of a hard, durable, industrial-strength material. For instance, the body 51 is made of a hard plastic. Additionally, the first device 50 may have an overmold 55 that wraps around the body 51. As shown, the overmold 55 is made of a durable rubber material that serves to provide cushion to the body 51 in the event that the first device 50 is dropped onto a hard surface. The first device 50 can also have a handle 90, which allows a user 41 to easily hold onto the first device 50 without risk of dropping the first device 50. Additionally, the body 51 can be waterproof or water resistant, such that the first device 50 is protected from water damage. Additionally, the first device 50 of the vehicle backing assistance system 40 could be made of a buoyant material capable of floating. This configuration could be used, for instance, in connection with a boat trailer. In the event that the first device 50 becomes dislodged, it could then easily be found as it floats to the surface of the water. Also, the body 51 can include a heatsink 88 formed in the back of the body 51. The heatsink 88 is configured to help to dissipate heat from the various electronics out of the body 51. The first device 50 is therefore operable in temperatures ranging from −20 degrees Fahrenheit to 130 degrees Fahrenheit.

The body 51 of the first device 50 can have additional features, including a camera 53, a light source 68, a proximity sensor 78, and a microphone 80. The camera 53 is used to capture video, images, and the like from wherever the first device 50 is mounted. Preferably, the camera 53 is a high definition camera, although the camera could also be other cameras such as an infrared camera or other cameras with night vision functionality depending on how and when the system 40 is used. The light source 68 is preferably a high intensity LED light that can provide additional lighting where the area around the first device 50 does not have sufficient lighting to see what is located adjacent to the camera 53. The specific brightness of the light can be adjusted by the user, or an additional brightness sensor (not shown) can be included in the body 51 that detects the amount of light that is needed and automatically adjusts the light source 68 accordingly. Additionally, the body 51 may have an ultra-sonic proximity sensor 78 that is capable of detecting objects that are in close relation to the first device 50. While an ultra-sonic proximity sensor 78 is shown, other proximity range sensors could be used as known to those of ordinary skill in the art. The sensor 78 could also be capable of measuring and displaying the distance to different objects located adjacent to the first device 50, for instance, a loading dock. Finally, the microphone 80 captures audio from wherever the first device 50 is mounted. This can be helpful where individuals located in close proximity to the first device 50 can vocally communicate with other individuals who are close to the second device 52, which typically is distanced from the first device 50. While the illustrated embodiment only has a single camera 53, a single light source 68, a single proximity sensor 78, and a single microphone 80, it will be appreciated that the first device 50 may include multiple of any of these features.

Additionally, the first device 50 may include a way to communicate the video, images, proximity sensor readings, audio, and any other information to the second device 52 by any way known to those skilled in the art. The first device 50 includes hardware capable of transmitting any measured or recorded information wirelessly to the second device 52. For, instance, a communication antenna can be located within the handle 90 or body 51 to allow the first device 50 to communicate wirelessly with the second device 52. For instance, the antenna or any other hardware housed within the handle 90 or body 51 could wirelessly connect through an internet connection, through a Bluetooth connection, through a radio connection, through a phone connection, or through any other wireless connection as known to those of ordinary skill in the art. Additional hardware could be enclosed within the handle 90 or body 51 as needed to communicate wirelessly with the second device 52. Additionally, a connection strength indicator could be provided. Alternatively, the first device 50 and the second device 52 could be connected using a wire or other physical connection.

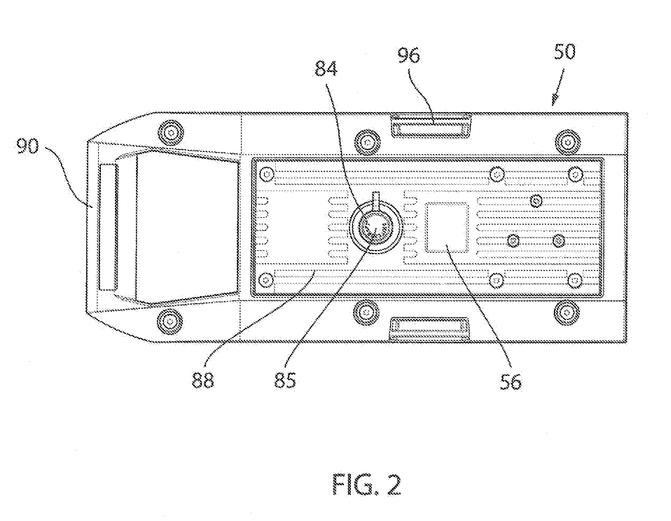

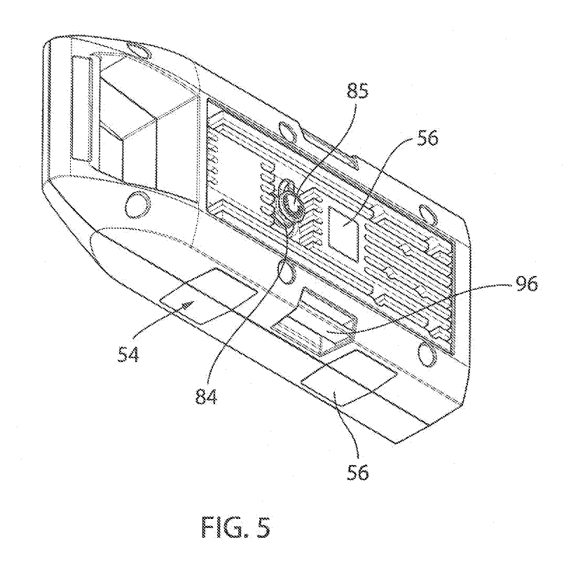

The first device 50 may be powered by a rechargeable battery (not shown) that is housed within the body 51. This allows the first device 50 to be powered without having to physically be attached to an exterior power source. As seen in FIGS. 2 and 5, the body 51 may include a port 84 configured to receive a battery charger that allows the battery to be recharged. For instance, the charger could be a 12-volt charger connected to the vehicle power source or it could be a 12-volt charger powered by an AC power adaptor. Further still, the charger could be a 12-volt charger that receives power from solar panes. A protection plug 85 can also be included that allows the port 84 to be sealed when the battery is not being charged. Additionally, looking to FIGS. 1, 3, and 4, the body 51 may additionally include a battery level indicator 86. The battery level indicator 86 provides a visual way to determine the remaining amount of battery charge, and thus how long the first device 50 can be used before it needs to be recharged. The battery level indicator 86 can also be used to monitor the charging of the battery when the charger is plugged into the port 84. The first device 50 also has a power button 94 that allows a user to turn on the first device 50 when in use and turn off the first device 50 to conserve the amount of battery that remains when the first device 50 is not in use. The power button 94 could also control other aspects of the first device 50 based on holding down the button 94 or pressing it multiple times. For instance, when this occurs, the power button 94 could control the intensity of the light source 68.

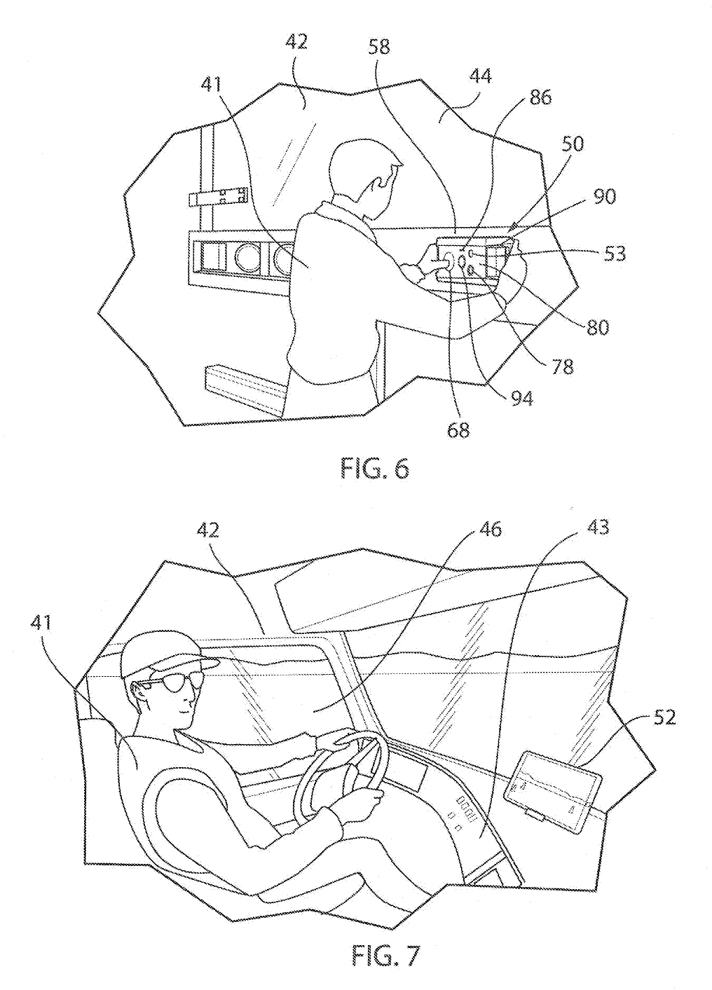

The first device 50 also has at least one attachment mechanism 54 that allows the first device 50 to be secured to an object, for instance, the rear end 44 of a vehicle 42 as shown in FIG. 6. For instance, the first device may include a plurality of high power magnets 56 located along the exterior of the body 51. As shown in the figures, the magnets 56 are oriented in the body 51 to give the first device 50 at least four flat mounting surfaces. Since many vehicles 42 have metallic materials 58 located at the rear end 44 of the vehicle 42, the plurality of high-powered magnets 56 allow the first device 50 to be easily mounted to vehicle 42. Due to the strength of these magnets 56, the first device 50 will remain securely connected to the rear end 44 of the vehicle until a user 41 physically removes the first device 50. The ease with which the first device 50 can be installed and removed from a vehicle 42 allows the user 41 to easily apply the device 40 to different vehicles 42 throughout a given day. These magnets 56 allow the first device 50 to be quickly and easily mounted or dismounted from a metallic object, including the rear end 44 of a vehicle 42. Additionally, as shown in FIGS. 2-5, strap openings 96 can be formed in the sides of the body 51 or the overmold 55. Straps (not shown) can be threaded through the strap openings 96 in order to secure the first device 50 to a non-metallic object. Additionally, the first device 50 may have other attachment mechanisms 54, for instance clamps, mounting brackets, screws, bolts, fasteners, suction cups, and the like.

Furthermore, the vehicle backing assistance first device 50 could be any number of colors based on the desired use. For instance, the first device 50 could be fluorescent so that it would be easy to locate by the user 41. This would also offer the benefit that it would allow individuals moving around the rear end 44 of the vehicle 42 to easily see the first device 50 and thus the rear end 44 of the vehicle. In certain uses, the first device 50 could be used outdoors, for instance, in hunting or military vehicle situations to monitor live footage at remote locations. In these cases, the first device 50 could be camouflaged. Further still, the color of the first device 50 could be customized based on an individual user's preference.

Of course, the features described with the first device 50 need not be arranged or located as shown in the figures. Instead, any of these features could be located anyway about the body 51, the overmold 55, and the handle 90. Additionally, it should be noted that any of the features described with the first device 50 could also be controlled remotely using the second device 52, as will further be described below.

Additionally, it should be noted that the first device 50 could be in communication with multiple different second devices 52 capable of displaying images, video, audio, and the like taken from the first device 50. As a result, multiple users would be able to see the images collected by the first device 50. This would be especially helpful during complicated deliveries that require multiple parties to be involved or when offsite help is required. The application could also allow the user 41 (driver of the vehicle) to communicate with another individual, for instance a spotter located remotely from the vehicle, for instance at the rear end of the vehicle.

In addition to transmitting directly to a number of second devices 52, the first device 50 could also broadcast live through the internet to users streaming various information, including the video, images, audio, etc. collected. Alternatively, the first device 50 could first transmit information to a second device 52, which then broadcasts the information live through the internet. Similarly still, multiple first devices 50 could be used to provide alternative camera views showing different perspectives. As a result, multiple views could be collected and displayed. Further still, there could be multiple first devices 50 and multiple second device 52 to improve functionality of the system 40.

As previously stated, the second device 52 could be any device that includes a monitor capable of displaying images, video, or other information taken from the first device 50 remotely, for instance, from a front cab 46 of a vehicle 42 as shown in FIG. 7. As such, the second device 52 could be a smartphone, a tablet, or a computer. Additionally, the second device 52 could be any computer associated with a vehicle 42, including a computer located in the dashboard 43 of the vehicle 42.

The second device 52 may come with software installed therein that is capable of collecting and displaying information transmitted from the first device 50. The software can also be downloaded at a later time to the second device 52. For convenience, the software could take the form of an application accessible through a smart device store, for instance the Apple App Store or Android App store. The application would run the software discussed below. Additionally, the first device 50 preferably comes with software pre-installed, which would allow a second device 52 to automatically connect to and interact with the first device 50 once the software or application is downloaded.

The software allows a user to easily monitor activities occurring close to the first device 50 from a distance through the second device 52. For instance, the software allows the second device 52 to display and play real-time video, real-time images, real-time audio, real-time proximity measurements, and the like that are collected by the first device 50 by the camera 53, microphone 80, and proximity sensor 78. Additionally, the real-time video could be a mirror view that is matches views from side mirrors, or a true view that simulates how it would, look if you were sitting at the back of the vehicle. Further still, the battery level and/or charging level of the first device 50 can be monitored by the second device 52.

Additionally, the software allows a user to interact with and change the settings of the first device 50 and the components associated therewith remotely using the second device 52. For instance, the software could allow a user to adjust the microphone 80 sensitivity and the proximity sensor 78 sensitivity, as well as the strength of the light source 68, either automatically or manually. Somewhat similarly, the second device 52 could adjust the viewing angle and focus range of the camera 53. The software can also adjust any of the contrast of real-time video or images, the magnification of the real-time video or images, the video speed, the video picture resolution, or the audio volume output automatically or manually based on a user's input. The real-time video speed and video picture resolution could be adjusted based on the signal strength, where reduced, speed or resolution would occur when the signal is not strong.

The software can also automatically control and/or manipulate information transmitted by the first device 50. For instance, the audio volume can automatically be controlled and changed to account for emergency beeping that occurs if any object is detected immediately adjacent to the vehicle. The frequency of the beeping can increase where first device 50 gets closer to any such objects. Also, the software can apply a depth grid automatically to the video image so that the user can better visualize where the vehicle will go. This grid can be projected based on measurements from the proximity sensor 78.

GPS capabilities associated with one of the first device 50 and the second device 52 could be used in connection with the software to provide additional benefit to a user, including for mapping purposes. For instance, where a user 41 approaches a delivery facility, an aerial view of the facility could be provided. This would allow the user 41 to quickly and easily identify where the load would need to be delivered, which is especially helpful where a distribution hub has hundreds of bays or locations where bays are difficult to locate. Once a given bay or location is selected, the software could be used to provide a guide route from the current location to the selected location. Once the user 41 guides the vehicle 42 close to the delivery spot, the user 41 could park the vehicle 42, exit the vehicle, walk to the rear end 44 of the vehicle 42, and install the first device 50 to the rear end 44 of the vehicle 42. The user 41 could then use the vehicle backing assistance system 40, and more specifically the second device 52 to view video that is being transmitted from the first device 50.

Further, the distance between the first device 50 and second device 52 can be monitored. This could occur based on the wireless connection, or lack thereof when the vehicle leaves without the first device 50. Alternatively, this could occur using the GPS capabilities of the first device 50 and second device 52. These features would allow a user to be notified when they inadvertently leave the first device 50 or second device 52 behind.

Also, the software can be equipped to collect and store information for future review either on the first device 50, the second device 52, or remotely, for instance, in a remote information storage facility or cloud. By storing information collected by the first device 50 and second device 52, users can learn from previous trips and plan accordingly for future trips. For instance, the application could collect information relating to the user's 41 location and trucking routes. Moreover, the software could allow the user to make location notes and collect images for future reference. Additionally, the number of successful backing attempts could be collected and tallied. Any of this information could be publicly available to others with a vehicle backing assistance system 40, or it could be private from other users. Along these lines, information can automatically be transferred to others. For instance, information relating to an individual's location or completion of a successful docking could be automatically transmitted to the dispatch office. This could be helpful in maximizing efficiency.

The software and application can provide additional features to improve the user's experience. For instance, the software could provide a user 41 with tutorials to allow the user 41 to easily understand the vehicle backing assistance system 40 and all of its features. Similarly, the software can come loaded with safety precaution videos. Additionally, the software could provide a troubleshooting guide, which would help a user 41 overcome obstacles experienced during the operation of the vehicle backing assistance system 40.

The application could also be used to display advertisements to the user 41. These advertisement spots could be purchased by anyone, including those in the trucking industry such as truck stop owners and vendors. These advertisements could provide exclusive deals to the user 41 to encourage them to continue to use the vehicle backing assistance system 40 and the application.

The vehicle backing assistance system 40 could also be promoted to potential customers, such as professional truck drivers, by allowing them to test out the vehicle backing assistance system 40. To encourage this testing, the professional truck drivers could be provided with various incentives upon completion of a trial. For instance, upon completion of a trial, the potential driver could be given food, beverage, merchandise, or even discounts on the vehicle hacking assistance system 40. Alternatively, credits to truck stops, for instance that would allow the potential customer to take a complimentary shower, could be provided.

Additional features may be used with the vehicle hacking assistance system 40. For instance, a solar power system (not shown) could be affixed to the roof of the vehicle 42 by a user 41 or another individual. Considering most vehicles, are exposed to sunlight during the day, significant energy collection could occur. These panels could be attached to a battery such that the user 41 could later use this generated energy. For instance, the battery could power the vehicle backing assistance system 40. Additionally, where another individual pays to have the solar panels installed, the user 41 could then pay the other individual for power usage. The solar panels could also be used to heat water for use with a shower.

Additionally, a method of using a vehicle backing assistance system 40 includes the following steps. Initially, the first device 50 is mounted to a rear end 44 of a vehicle 42, as shown in FIG. 6. Next, the first device 50 wirelessly connects to a second device 52. Real-time video is then captured and transmitted from the first device 50 to the second device 52. This allows a user 41 to monitor the real-time video as the vehicle 42 is moved, for instance, from a front cab 46 of a vehicle 42 as shown in FIG. 7. Similarly, audio and/or proximity detection is then captured and transmitted from the first device 50 to the second device 52. As a result, the audio and proximity detection can be monitored on the second device 52 as the vehicle 42 is moved. Once the user 41 has completed the backing procedure, the first device 50 could be dismounted from the rear end 44 of the vehicle 42. The first device 50 could then be mounted to a rear end of a second vehicle in the same way as shown in FIG. 6. The steps of the method could be done in any order, and some steps need not be performed. Further, additional steps could also be performed to enhance use of the vehicle backing assistance system 40.

All the disclosed embodiments are useful in conjunction with a vehicle when driven in reverse, which can be difficult especially when a user's vision behind the vehicle is blocked. There are virtually innumerable uses for the present invention, all of which need not be detailed here. All the disclosed embodiments can be practiced without undue experimentation.

Although the best mode contemplated by the inventors of carrying out the present invention is disclosed above, practice of the present invention is not limited thereto. It will be manifest that various additions, modifications and rearrangements of the features of the present invention may be made without deviating from the spirit and scope of the underlying inventive concept.

For example, any one of the above-described vehicle backing assistance systems 40 and features described therewith may be used with any one of the first device 50 and second device 52. Also, any features described with the first device 50 could conceivably be used with the second device 52. The same can be said for features described with the second device 52, which could also be used with the first device 50. Additional vehicle backing assistance systems 40 could also be used in order to improve the convenience, effectiveness, and safety of backing up the vehicle 42.

Moreover, the illustrations provide exemplary vehicle backing assistance systems, and the individual components need not be formed in the disclosed shapes, or assembled in the disclosed configuration, but could be provided in virtually any shape, and assembled in virtually any configuration. Further, although the first device 50 and the second device 52 described herein are physically separate, they could also be physically connected. Additionally, it should be understood that any wireless communication could be employed to connect the first device 50 and the second device 52. Furthermore, all the disclosed features of each disclosed embodiment can be combined with, or substituted for, the disclosed features of every other disclosed embodiment except where such features are mutually exclusive. Further still, any of the features disclosed herein could also be combined with, or substituted for, the features disclosed in Provisional Patent Application Ser. No. 62/314,457, filed on Mar. 29, 2016, and entitled Vehicle Backing Assistance Device, which this application claims priority to, and which is incorporated by reference in full into this application.

It is intended that the appended claims cover all such additions, modifications and rearrangements. Expedient embodiments of the present invention are differentiated by the appended claims.

What is claimed is:

1. A vehicle backing assistance system comprising:
a first device with a body and a camera, where the body is releasably connected to a rear end of a vehicle,
a second device spaced apart from the first device, the second device having software capable of receiving and displaying images taken by the camera and transmitted from the first device.

2. The vehicle backing system device of claim 1 wherein the first device further comprises an attachment mechanism to allow first device to be releasably attached to the rear end of the vehicle.

3. The vehicle backing assistance system of claim 2 wherein the attachment mechanism is at least one magnet connected to the first device to allow the first device of the vehicle backing assistance system to be releasably attached to a metallic surface on the rear end of the vehicle.

4. The vehicle backing assistance system of claim 2 wherein the attachment mechanism is selected from a group consisting of a mounting bracket, a clamp, a strap, a screw, a bolt, and a fastener.

5. The vehicle backing assistance system of claim 2 wherein the second device is selected from a group consisting of a smartphone, a tablet, and a computer.

6. The vehicle backing assistance system of claim 5 wherein the vehicle is selected from a group consisting of a commercial motor vehicle, a military defense vehicle, an emergency vehicle, a personal camper, a boat trailer, an all-terrain vehicle trailer, a heavy equipment trailer, a bus, and a construction crane.

7. The vehicle backing assistance system of claim 6 wherein a user can view the images from the rear end of the vehicle collected by the first device at a front cab of the vehicle using the second device.

8. The vehicle hacking assistance system of claim 1 wherein the first device further comprises a light source configured to illuminate the rear end of the vehicle.

9. The vehicle backing assistance system of claim 8 wherein an amount of power supplied to the light source can be varied.

10. The vehicle backing, assistance system of claim 9 further comprising a light sensor configured to adjust the power supplied to the light source.

11. The vehicle backing assistance system of claim 1 wherein the first device further comprises a proximity sensor.

12. The vehicle backing assistance system of claim 1 wherein the first device further comprises a microphone.

13. The vehicle backing assistance system of claim 1 wherein at least one of the first device and the second device are powered by solar panels mounted to the vehicle.

14. The vehicle backing assistance system of claim 1 wherein the first device is substantially water resistant.

15. The vehicle backing assistance system of claim 14 wherein the vehicle is a boat trailer, and wherein the first device is made of a buoyant material capable of floating.

16. The vehicle backing assistance system of claim 1 wherein the first device further comprises:
a rechargeable battery;
a battery charger;
a port configured to accept the battery charger;
a battery level indicator; and
a heatsink for dissipating heat from the first device.

17. A method of using a vehicle backing assistance system comprising the steps of:
mounting a first device with a camera to a rear end of a vehicle;
wirelessly connecting the first device to a second device;
capturing a real-time video with the camera;
transmitting the real-time video from the first device to the second device; and
monitoring the real-time video on the second device as the vehicle is moved.

18. The method of claim 17, further comprising the steps of:
capturing a real-time audio through a microphone contained within the first device;
transmitting the real-time audio from the first device to the second device; and
monitoring the real-time audio on the second device as the vehicle is moved.

19. The method of claim 17, further comprising the steps of:
capturing real-time information related to a plurality of physical items located about the rear end of the vehicle using a proximity sensor contained within the first device;
transmitting the real-time information related to the plurality of physical items located about the rear end of the vehicle from the first device to the second device; and
monitoring the real-time information related to the plurality of physical items located about the rear end of the vehicle on the second device as the vehicle is moved.

20. The method of claim 17, further comprising the steps of:
dismounting the first device from the rear end of the vehicle; and
mounting the first device to a rear end of a second vehicle.
